(19) United States
(12) Patent Application Publication
(10) Pub. No.: US 2025/0167864 A1
(43) Pub. Date: May 22, 2025

(54) BEAM MANAGEMENT FOR COMMUNICATION VIA NETWORK CONTROLLED REPEATERS AND RECONFIGURABLE INTELLIGENT SURFACES

(71) Applicant: Telefonaktiebolaget LM Ericsson (publ), Stockholm (SE)

(72) Inventors: Behrooz MAKKI, Pixbo (SE); Magnus ÅSTRÖM, Lund (SE); Andreas NILSSON, Göteborg (SE)

(73) Assignee: Telefonaktiebolaget LM Ericsson (publ), Stockholm (SE)

(21) Appl. No.: 18/838,655

(22) PCT Filed: Feb. 24, 2022
(86) PCT No.: PCT/EP2022/054735

§ 371 Date: Aug. 15, 2024

(51) Int. Cl. H04B 7/06; H04B 7/04

(52) U.S. Cl. CPC H04B 7/06952; H04B 7/04013

(57) ABSTRACT

A computer implemented method performed in a network node (120), the method comprising configuring an advanced antenna system, AAS, of the network node (120) to generate a relay antenna beam associated with transmission to and from a repeater node (150) of the network node (120), the method further comprising generating at least two different first synchronization signals, and transmitting the at least two different first synchronization signals via the relay antenna beam towards the repeater node (150).

### TECHNICAL FIELD

The present disclosure relates to techniques for managing radio transmission and reception using advanced antenna systems (AAS) in wireless access networks. There are disclosed methods and devices for communication via network controlled repeaters and reconfigurable intelligent surfaces (RIS).

### BACKGROUND

The coverage of a radio system is primarily governed by the properties of the radio propagation environment in which the radio system is deployed. Some environments are more difficult than others when it comes to providing ubiquitous radio access coverage to wireless devices. For instance, urban environments often comprise many large objects, such as buildings, which block direct line-of-sight radio propagation from an access point to the wireless devices in vicinity of the access point.

AAS improve radio communication system performance by forming beams with an increased directivity in some fixed or adaptive direction of communication. Beam management procedures have been developed, e.g., by the third generation partnership program (3GPP) to manage AAS operation in modern wireless access networks. These beam management procedures also comprise beam link failure procedures that are triggered in case a beam is suddenly blocked or becomes unavailable for some other reason. Beam management is discussed in, e.g., 3GPP TR 38.912 V.16.0.0, 2020 Jul. 18.

Methods for actively altering the physical radio propagation environment have recently gained considerable interest, for instance by the 3GPP. Such methods comprise both network controlled repeaters and reconfigurable intelligent surfaces (RIS). These devices are adapted to “bend” radio transmission beams used for communication by a network node, such as a gNB, and can therefore be used to improve the multipath propagation properties of a given environment, thereby improving both network coverage and radio communication performance. However, the introduction of RIS and network controlled repeaters complicate beam management procedures in the wireless access networks.

Repeaters and RIS devices are discussed, e.g., in “New SID on NR Smart Repeaters”, RP-212703, 3GPP TSG RAN Meeting #94e, Dec. 6-17, 2021. The topic is also discussed in “NR repeaters and Reconfigurable Intelligent Surface”, RWS-210300, 3GPP TSG RAN Rel-18 workshop, June 2021 and in “Introducing Intelligent Reconfigurable Surfaces for 5G-Advanced”, RWS-210306, 3GPP TSG RAN Rel18 workshop, June 2021.

However, despite the work done to-date, there is a need for updated beam management procedures and wireless access network control methods which are efficient also in presence of RIS and/or network controlled repeaters.

### SUMMARY

It is an object of the present disclosure to provide methods, network nodes and repeater nodes such as network controlled repeaters and RIS which resolve or at least alleviate some or all of the above-mentioned issues.

This object is at least in part obtained by a computer implemented method performed in a network node. The method comprises configuring an AAS of the network node to generate a relay antenna beam associated with transmission to and from a repeater node of the network node. The method further comprises generating at least two different first synchronization signals and transmitting the at least two different first synchronization signals via the relay antenna beam towards the repeater node.

This way an efficient beam management scheme is enabled which also accounts for the presence of repeater nodes, such as one or more RIS and/or network controlled repeaters. Particularly, the joint determination of the repeater node configuration and the network node AAS configuration enables the integration of repeater nodes into the network in an efficient manner. In this way, the repeater node help to, e.g., bypass radio propagation blockages, and avoid performance drop (beam link failure) of the UEs. This results in coverage extension and a more constant quality of service (QoS) experience for the UEs.

According to aspects, the method comprises generating the at least two different first synchronization signals as different SSB beams. This allows re-use of existing 3GPP signaling formats and procedures to perform the updated beam management which allowing incorporation of repeater node beams. As will be discussed in more detail in the following, the transmission of SSBs via the repeater node enables an efficient course repeater setting which can then be refined.

The method may comprise configuring the repeater node with a first configuration parameter prior to transmitting the at least two different first synchronization signals via the relay antenna beam, where the first configuration parameter is adapted to control a relaying characteristic of the repeater node. Thus, the repeater node is configured to forward the first synchronization signals according to a first configuration parameter. The relaying characteristic of the repeater node may comprise any of a relaying angle, a relaying direction, a relaying beam width, an amplification setting, and/or an antenna pattern of the repeater device. The relaying characteristic may also comprise a time instant and/or periodicity during which the first configuration parameter should be applied. This way the forwarding behaviour for the first synchronization signals can be adapted for optimizing the overall network function.

According to aspects, the method also comprises receiving a message at the network node from a wireless device via the relay antenna beam. The message is indicative of a radio link quality between the network node and the wireless device via the repeater node. The method also comprises generating at least two different second synchronization signals and transmitting the at least two different second synchronization signals via the relay antenna beam towards the repeater node. The second synchronization signals allow for functionality beyond that offered in case only the first synchronization signals are transmitted, such as a refinement of the initial beam configuration at the repeater node. The at least two different second synchronization signals may for instance be generated as different CSI-RS. The method may also comprise configuring the repeater node with a second configuration parameter prior to transmitting the at least two different second synchronization signals via the relay antenna beam towards the repeater node, where the second configuration parameter is adapted to control the relaying characteristic of the repeater node. The second configuration parameter is preferably different from the first configuration parameter which was used when transmitting the first synchronization signals. The first configuration parameter may for instance be associated with a lower degree of antenna beam directivity compared to the second configuration parameter, i.e., the second configuration parameter may entail a refinement of the beam configuration to further optimize communication via the repeater node.

The message received from the wireless device optionally comprises a beam failure recovery request (BFRQ) message or a beam report message. This way the established procedures for handling beam failure can be reused also in the repeater device beam management methods discussed herein, which is an advantage. A radio link between a wireless device and the network node via the repeater node can be quickly redirected to another repeater node beam or antenna configuration in case a beam failure, which is an advantage.

The number of first and/or second synchronization signals transmitted via the relay antenna beam towards the repeater node can advantageously be determined in dependence of a number of forwarding directions of the repeater node. This means that the number of first and/or second synchronization signals are multiplexed onto respective outgoing beams form the repeater node, effectively increasing the number of beams generated by the network node to also comprise “dog-leg” beams that are bent in different directions by the repeater node.

According to other aspects, the method also comprises receiving information related to the repeater node, determining a configuration of the relay antenna beam associated with transmission to and from the repeater node of the network node, and storing the configuration of the relay antenna beam together with its associated repeater node. This way the relay antenna beam can be configured for efficient communication to and also from the repeater node. Many different ways of configuring the relay antenna beam are disclosed below. For instance, the method may comprise obtaining the information related to the repeater node from another network node and/or from a local storage medium of the network node, determining the configuration of the relay antenna beam at least in part based on a geographical position of the repeater node relative to the network node, determining the configuration of the relay antenna beam at least in part based on a beam management procedure involving a wireless device served via the repeater node, determining the configuration of the relay antenna beam at least in part based on computer simulation involving a digital twin structure adapted to model at least a part of a wireless access network comprising the network node and the repeater node, determining the configuration of the relay antenna beam at least in part based on radar operation involving the network node, and/or determining the configuration of the relay antenna beam at least in part based on reflection of a signal transmitted from the network node towards the repeater node.

The above stated object is also at least in part obtained by a computer implemented method performed in a repeater node. The method comprises receiving at least two different first synchronization signals from a network node configured with a relay antenna beam and configuring a first relaying characteristic of the repeater node to forward the received first synchronization signals differently from the repeater node. Thus, the plurality of first synchronization signals received from the network node via the relay beam are directed differently to cover a pre-determined area. The first synchronization signals can therefore be responded to by wireless devices located within the overage area of the repeater node, and a reliable high performing communication link can thus be established between the wireless device and the network node, via the repeater node.

According to some aspects, method comprises receiving configuration data adapted for configuration of the first relaying characteristic. This allows a node remote from the repeater node to configure the repeater node. The remote nide may for instance be the network node, but it can also be some other node in the wireless access network, such as a configuration entity of some sort.

The method may furthermore comprise obtaining time synchronization with respect to the network node. After obtaining time synchronization, the repeater node is able to adapt its operation to the frame structure used at the network node, to multiplex transmissions from the network node in different directions in an accurate manner. The method optionally also comprises adapting the first and/or second relaying characteristic in dependence of a random access frame structure of the network node, which feature becomes enabled in an efficient manner in case time synchronization is first achieved between the network node and the repeater node.

According to some aspects, method comprises receiving at least two different second synchronization signals from the relay antenna beam of the network node and configuring a second relaying characteristic of the repeater node to forward the received second synchronization signals differently from the repeater node. Again, this allows for a beam refinement compared to the forwarding of the first synchronization signals, which is an advantage. As already mentioned above, the first and/or second relaying characteristic comprises any of: a relaying angle, a relaying direction, an amplification setting, a relaying beam width, and/or a relaying power amplifier setting. The first and/or second relaying characteristic may also comprise a time instant and/or periodicity during which the respective first and/or second configuration should be applied. It is furthermore conceivable to adapt the first and/or second relaying characteristic in dependence of an (UL) format of the network node. According to further aspects, the method comprises synchronizing a change in relaying angle, relaying direction, and/or relaying beam width of the repeater node in dependence of a SSB beam time structure of the network node. This way the repeater operation can be matched to the scheduling of the transmissions from the network node to different wireless devices, and also matched to the frame structure of the transmissions from the network node to wireless devices and over different parts of the coverage area of the joint repeater node and network node system. It is also appreciated that the network node may have access to more than one repeater node, and that the aggregate system of a network node and a plurality of repeater nodes becomes a powerful coverage tool able to serve also wireless devices which are located in challenging locations relative to the network node in terms of radio propagation, such as behind blocking objects. The method may furthermore comprise synchronizing a change in relaying angle, relaying direction, and/or relaying beam width of the repeater node in dependence of a random access frame time structure of the network node.

There are also disclosed herein network nodes, repeater nodes, computer programs and computer program products associated with the above-mentioned advantages. It is furthermore appreciated that many of the aspects of the methods discussed herein can be operated separately from one or more the aspects, as will be made clear from the below detailed description.

### BRIEF DESCRIPTION OF THE DRAWINGS

The present disclosure will now be described in more detail with reference to the appended drawings, where:

FIG. 1 schematically illustrates an example wireless access network;

FIG. 2 exemplifies beam management between a network node and a wireless device;

FIGS. 3-4 illustrate example communication scenarios involving a reconfigurable surface;

FIGS. 5A-B show beam management during communication via a network controlled repeater;

FIG. 6 schematically illustrates a network controlled repeater node;

FIGS. 7A-D are flow charts illustrating example methods;

FIG. 8 exemplifies beam management between a network node and a repeater node;

FIG. 9 schematically illustrates processing circuitry; and

FIG. 10 shows an example computer program product.

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

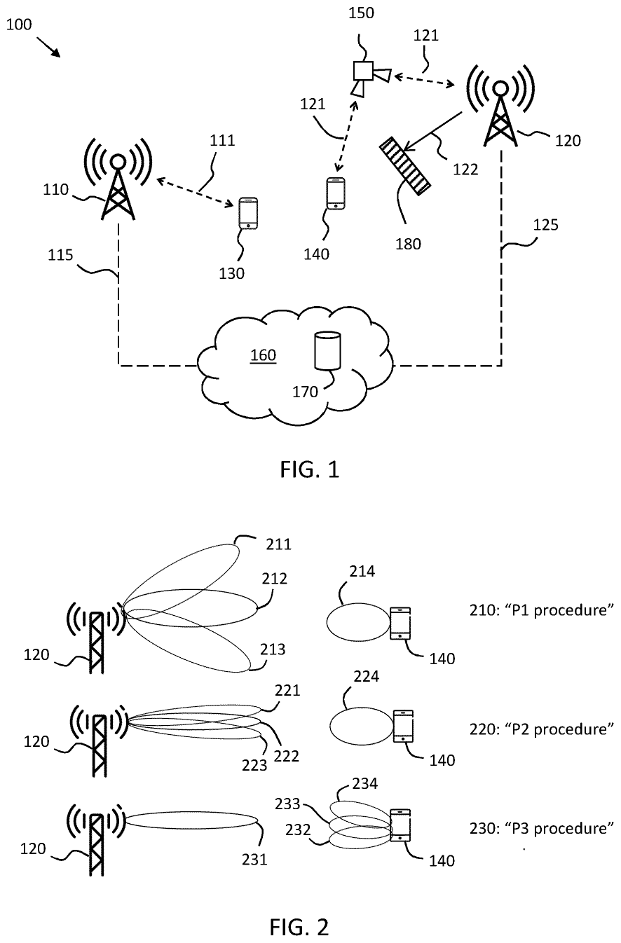

FIG. 1 illustrates an example wireless communication system 100, where access points 110, 120 provide wireless network access to wireless devices 130, 140, also known as user equipment (UE), over respective coverage areas. An access point in a fourth generation (4G) third generation partnership program (3GPP) network is normally referred to as an evolved node B (eNodeB), while an access point in a fifth generation (5G) 3GPP network is referred to as a next generation node B (gNodeB). The access points 110, 120 are connected 115, 125 to some type of core network 160, such as an evolved packet core network (EPC). The EPC is an example of a network which may comprise wired communication links, such as optical links. One or more remote servers 170 may be comprised in the core network. These remote servers may be used to store data and/or to perform data processing and configuration operations which operations often comprise various forms of network optimization such as configuration of the different antenna systems at the network nodes.

The wireless access network 100 supports at least one radio access technology (RAT) for communicating 111, 121 with the wireless devices 130, 140. It is appreciated that the present disclosure is not limited to any particular type of wireless access network type or standard, nor any particular RAT. The techniques disclosed herein are, however, particularly suitable for use with 3GPP defined wireless access networks, and in particular those based on orthogonal frequency division multiplexing (OFDM).

An access point may be associated with one or more transmission points (TRP). A TRP may comprise an AAS capable of generating a plurality of antenna beams in a known manner. An antenna beam is herein to be construed broadly to encompass an antenna pattern where the gain is not isotropic but concentrated in one or more directions (often in a single direction—often denoted an antenna beam direction). Antenna beams are generally bidirectional, i.e., can be used for both transmission and reception of radio signals.

The environment in which the wireless access network 100 has been deployed normally comprises objects 180 such as buildings and other obstructions which may block a line-of-sight (LOS) radio propagation path 122 between an access point 120 and a wireless device 140. To improve radio propagation between access points and wireless devices in the presence of blocking objects, relaying techniques have been proposed. Relaying essentially means that a repeater node 150 of some kind is deployed in the environment where it is used to forward radio signals between radio transceivers, thus reducing the detrimental effects of objects 180 which obstruct LOS radio propagation channels, as shown in FIG. 1.

Herein, a repeater node 150 may at times be exemplified by a RIS or a network controlled repeater. The term relaying device or just relay may also be used. The common denominator for these devices that are discussed herein is that they forward received radio signal without prior decoding of the information streams carried by the radio signals. Thus, a repeater node 150 acts like a “beam bender” which changes the direction of a radio signal transmission without actually decoding the information carried by the radio transmission.

To increase the obtainable data rates in the network 100 and also to support the rapidly increasing number of wireless devices to be served by the wireless access network 100, different methods have been considered, among which are network densification and millimeter wave communication. Network densification refers to the deployment of multiple access points of various types in, e.g., metropolitan areas. Particularly, it is expected that network devices such as relays, integrated access backhaul (IAB) systems, and repeater systems will be densely deployed to assist the existing macro base stations (BS).

IAB has been studied intensively by, e.g., the 3GPP in connection to the development of fifth generation (5G) network technologies. Here, using decode-and-forward relaying techniques, the IAB can extend the coverage and/or increase the throughput of most access networks. However, IAB normally involves relatively complex and expensive hardware and thus, depending on the deployment scenario, alternative technologies associated with reduced complexity and/or cost may be required for, e.g., blind spot removal and the like. Here, a candidate type of network node is the type of radio frequency (RF) repeaters which simply amplify-and-forward any signal that they receive. RF repeaters have seen a wide range of deployments in previous wireless access networks where they have been used with success to supplement the coverage provided by the regular full-stack cells. Traditional RF repeaters, however, lack, e.g., accurate beamforming capability which may limit their efficiency in, for instance, frequency range two (FR2). Traditional RF repeaters have also comprised fixed antenna pattern antenna systems, i.e., have not been equipped with reconfigurable AAS, which has limited their efficiency in some communication systems.

With this background it becomes interesting to evaluate the potential and the challenges associated with network controlled repeaters and RIS installments for use in modern wireless access networks, such as the network 100 schematically illustrated in FIG. 1. The scope and the features of such repeater nodes are still under discussion in the 3GPP and elsewhere. However, herein, a repeater node is to be construed as a normal repeater with beamforming capabilities, albeit not implementing any decoding of the received signal. In this way, the network controlled repeater should be considered as a network controlled “beam bender” relative to the gNB. As such, it is logically part of the gNB for all management purposes, i.e., it is likely that the network controlled repeater is deployed and under the control of the operator which manages the gNB. Network controlled repeaters are based on an amplify-and-forward relaying scheme, and are also likely to be limited to single-hop communication in stationary deployments with the main focus on FR2. The same can be said for RIS installments, i.e., they are configured to forward incoming radio signals in some configurable direction. Differences between RIS and network controlled repeaters will be discussed in more detail below.

How a network controlled repeater will be designed and how it will communicate with the network is still not clear in the standardization efforts. FIG. 6 illustrates one schematic example 600 of how it might look. It is appreciated that this is just an example of a possible network-controlled repeater structure, while the exact structure is still to-be-decided by 3GPP. In this example, the network controlled repeater consists of two building blocks, the repeater module 610 and the controller module 620. The repeater module is equipped with a repeater antenna configuration 630, where a signal is first received, and after power amplification, transmitted again (without decoding and detection of any information symbol carried by the signal). Since the repeater module only amplifies and beamforms the signal, no advanced receiver or transmitter chains are required, which reduces the cost and energy consumption compared to for example a normal TRP.

The controller module 620 is used to control the repeater module 610, by for example providing beamforming information, power control information, and the like. The controller module is connected to the network such that the network can control the controller module and, in that way, control e.g., the antenna configuration of the repeater module. The controller module is equipped with a controller antenna configuration module 640, TX chain, RX chain and a baseband module 650 in order to receive the control signaling from the network and providing the network with information about the network controlled repeater. Although depicted as separate antennas, the controller may use the repeater antennas, or a subset of the repeater antennas for its communication with the TRP (gNB/base station/network node)

The repeater module 610 and the controller module 620 could be communicating with two different TRPs (denoted TRP1 and TRP2 in FIG. 6) or one and the same TRP (not shown in FIG. 6). In case two different TRPs are used, the two TRPs can be located at the same location, or at separate locations, and the two TRPs can either communicate over the same frequency band or over different frequency bands. For example, TRP1 and TRP2 could be located at the same place, however, the repeater module could be operating at a high frequency band (FR2) and the controller module could be operating at a low frequency band (FR1) (in which case TRP1 and TRP2 are not necessarily collocated), even though perhaps the most likely scenario is that both the repeater module 610 and the controller module 620 is operating in FR2, at least in part since the FR2 frequencies give rise to “sharper shadows” radio-wise, i.e., more sudden and more severe loss of signal strength.

Regardless of whether TRP1 and TRP2 are located at the same or different locations, it is expected that a fast connection between them is preferred, since the control signaling from TRP2 used to control the network controlled repeater will likely depend on the momentaneous scheduling decisions of TRP1. For example, in case TRP1 schedules data transmission for a certain UE, the network controlled repeater should preferably be configured with a beam and power allocation associated with that particular UE.

RIS, also known as intelligent reflective surfaces (IRS) is as mentioned above an emerging technology that is capable of intelligently manipulating the propagation of electromagnetic waveforms. RIS is composed of a 2-dimensional array of reflecting elements, where each element acts as a passive reconfigurable scatterer, i.e., a piece of manufactured material, which can be “programmed” to change an impinging electromagnetic wave in a customizable way. Such elements are usually low-cost passive surfaces that do not require dedicated power sources, and the radio waves impinged upon them can be forwarded without the need of employing power amplifiers or complex RF chains. Moreover, RIS can, potentially, work in full duplex mode without significant self-interference or increase in noise level and requires only low-rate control link or backhaul connections. RIS can be flexibly deployed due to their low weight and low power consumption. Specially, RIS is of interest in stationary or low-mobility networks, in which the transmission parameters can be well planned and, e.g., blockages/tree foliage is bypassed through RIS-assisted communication.

To differentiate a RIS from a network controlled repeater, it can be argued that a RIS is a network controlled repeater with negative amplification. In general, RIS is expected to be a simpler and cheaper node with less focused beamforming capability/accuracy and without active amplification. That is, a RIS device may be capable of signal reflection via adapting a phase matrix while the network controlled repeater is capable of advanced beamforming with power amplification. Also, delay wise, RIS may have slightly lower latency, compared to a network controlled repeater. A RIS might have a similar design as the network controlled repeater 600 exemplified in FIG. 6, but without the signal amplification step 660 in the repeater module 610.

In the high frequency range defined by the 3GPP, i.e., in FR2, multiple RF beams may be used to transmit and receive signals at a gNB and a UE. For each downlink (DL) beam from a gNB, there is typically an associated best UE Rx beam for receiving signals from the DL beam. The DL beam and the associated UE Rx beam together form a beam pair. The beam pair can be identified through a so-called beam management process defined by the 3GPP for the new radio (NR) RAT.

A DL beam is (typically) identified by an associated DL reference signal (RS) transmitted in the beam, either periodically, semi-persistently, or aperiodically. The DL RS for the purpose can be a Synchronization Signal (SS) and Physical Broadcast Channel (PBCH) block (SSB) or a Channel State Information RS (CSI-RS). By measuring all the DL RSs, the UE can determine and report to the gNB the best DL beam to use for DL transmissions. The gNB can then transmit a burst of DL-RS in the reported best DL beam to let the UE evaluate candidate UE RX beams.

Although not explicitly stated in the NR specification, beam management has been divided into three procedures, schematically illustrated in FIG. 2:

P1 procedure 210: The purpose of the P1 procedure is to find a coarse direction for the UE using wide gNB 120 TX beams 211, 212, 213 covering a large angular sector. The UE 140 is configured with a reasonably broad beam 214.

The P1 procedure is expected to utilize beams with rather large beamwidths and where the beam reference signals are transmitted periodically and are shared between all UEs of the cell. Typically the reference signals used for the P1 procedure are periodic CSI-RS or SSB. The UE then reports the N best beams to the gNB and their corresponding RSRP values.

P2 procedure 220: The purpose of the P2 procedure is to refine the gNB 120 TX beam by doing a new beam search around the coarse direction found in P1. This is achieved by evaluating a number of more narrow candidate beams 221, 222, 223. The UE 140 maintains its beam 224 during the P2 procedure. The P2 procedure is expected to use aperiodic/or semi-persistent CSI-RS transmitted in narrow beams around the coarse direction found during the P1 procedure.

P3 procedure 230: This procedure is used for wireless devices 140 that implement beamforming in order to let the wireless device determine a suitable beam out of a plurality of UE candidate beams 232, 233, 234. The P3 procedure is expected to use aperiodic/or semi-persistent CSI-RSs repeatedly transmitted in one narrow gNB beam. One alternative way is to let the UE determine a suitable UE RX beam based on the periodic SSB transmission. Since each SSB consists of four OFDM symbols, a maximum of four UE RX beams can be evaluated during each SSB burst transmission. One benefit with using SSB instead of CSI-RS is that no extra overhead of CSI-RS transmission is needed.

In NR, several signals can be transmitted from different antenna ports of a given base station. These signals can have the same large-scale properties such as Doppler shift/spread, average delay spread, or average delay. These antenna ports are then said to be quasi co-located (QCL). If the UE knows that two antenna ports are QCL with respect to a certain parameter (e.g. Doppler spread), the UE can estimate that parameter based on one of the antenna ports and apply that estimate for receiving signal on the other antenna port. For example, there may be a QCL relation between a CSI-RS for tracking RS (TRS) and the physical downlink shared channel (PDSCH) demodulation reference signal (DMRS). When UE receives the PDSCH DMRS it can use the measurements already made on the TRS to assist the DMRS reception.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced in NR to facilitate beam management with analog beamforming and is known as spatial QCL. There is currently no strict definition of spatial QCL, but the understanding is that if two transmitted antenna ports are spatially QCL, the UE can use the same Rx beam to receive them. This is helpful for a UE that uses analog beamforming to receive signals, since the UE needs to adjust its RX beam in some direction prior to receiving a certain signal. If the UE knows that the signal is spatially QCL with some other signal it has received earlier, then it can safely use the same RX beam to also receive this signal. The concept of QCL can be used also when selecting preferred beams for communication by the repeater node 150.

In NR, the spatial QCL relation for a DL or UL signal/channel can be indicated to the UE by using a “beam indication”. The “beam indication” is used to help the UE to find a suitable RX beam for DL reception, and/or a suitable TX beam for UL transmission. In NR, the “beam indication” for DL is conveyed to the UE by indicating a transmission configuration indicator (TCI) state to the UE, while in UL the “beam indication” can be conveyed by indicating a DL-RS or UL-RS as spatial relation (in NR Rel-15/16) or a TCI state (in NR rel-17).

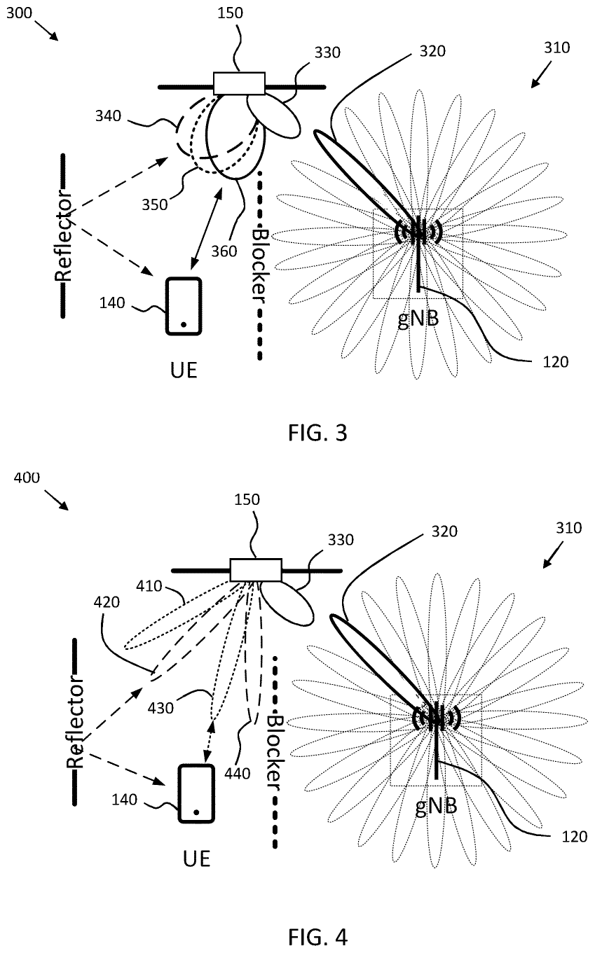

Blocking is expected to be common at above 6 GHz regime due to the narrow beams used at both the TRP and UE and the high penetration loss and diffraction loss at these high frequencies. To manage blocking at higher frequencies in NR a beam recovery procedure has been standardized (instead of relying on radio link failure (RLF) which is a much more costly and time consuming procedure). The purpose of the beam recovery procedure is to find an alternative beam pair link in case the active beam pair link is blocked, as illustrated in FIG. 3. The UE beam failure recovery mechanism consists of four parts:

A first part relates to beam failure detection. In this part the UE detects beam failure by monitoring a dedicated reference signal (CSI-RS or SSB) that is spatially QCL with PDCCH and assesses if a trigger condition has been met. The trigger condition is based on BLER for a hypothetical PDCCH based on the measurements on the dedicated DL-RS. A trigger condition is met (i.e., a beam link failure is declared) if the BLER for the hypothetical PDCCH is above a given threshold for X number of consecutive occasions (where X is configurable).

A second part relates to identification of a new candidate beam. In order to quickly find a candidate beam after a beam link failure the UE constantly monitors (e.g. measures RSRP on) beam identification RS, which for example can be SSB (or periodic CSI-RS if configured). Since SSB is expected to be beamformed at higher frequencies to attain coverage, the UE can determine a preferred candidate TRP SSB beam based on these measurements. Since each SSB consists of four OFDM symbols, the UE can also perform a UE RX beam sweep during each SSB transmission, and hence it is possible for the UE to determine both a suitable TRP beam and UE beam for the candidate BPL.

A third part relates to beam failure recovery request transmission. When the UE has declared a beam link failure and a new candidate beam has been determined, the UE transmits a beam failure recovery request (BFRQ) on UL to notify the network about the beam link failure. The BFRQ is a PRACH which implicitly informs the TRP about the preferred TRP SSB beam. The UE then monitors the response from the gNB, i.e., the beam failure recovery request response, to finalize the beam link recovery procedure.

To benefit from the above discussed repeater technologies, i.e., from network controlled repeaters and RIS, there is a need to adapt the existing beam management schemes to the cases with repeaters in-between the TRP and the wireless device, as schematically illustrated by the repeater 150 in FIG. 1. This requires joint optimization of the BS and the relay beams. Such a scheme enables a proper integration of the repeater node 150 with the network and guarantee fairly constant quality-of-service for the UEs even in the cases with, e.g., blockage. A purpose of the present disclosure is to develop efficient beam management schemes in the presence of repeaters such as network controlled repeaters and RIS. Here, considering, possibly, multi-SSBs by gNB and synchronizing them with their respective repeater beams, a two-step procedure is followed to determine the appropriate beams of the gNB and the repeater node. In this way, the repeater node and the TRP beams are jointly designed such that the UE can be served via the repeater node in an efficient manner.

The techniques discussed herein can be seen as an extension to the legacy beam management procedures in use today, where the beam set of the network node, i.e., the AAS configuration, is extended by more beams, where a beam directed towards a relay is expanded into several additional beams which are also configurable, at least to some extent.

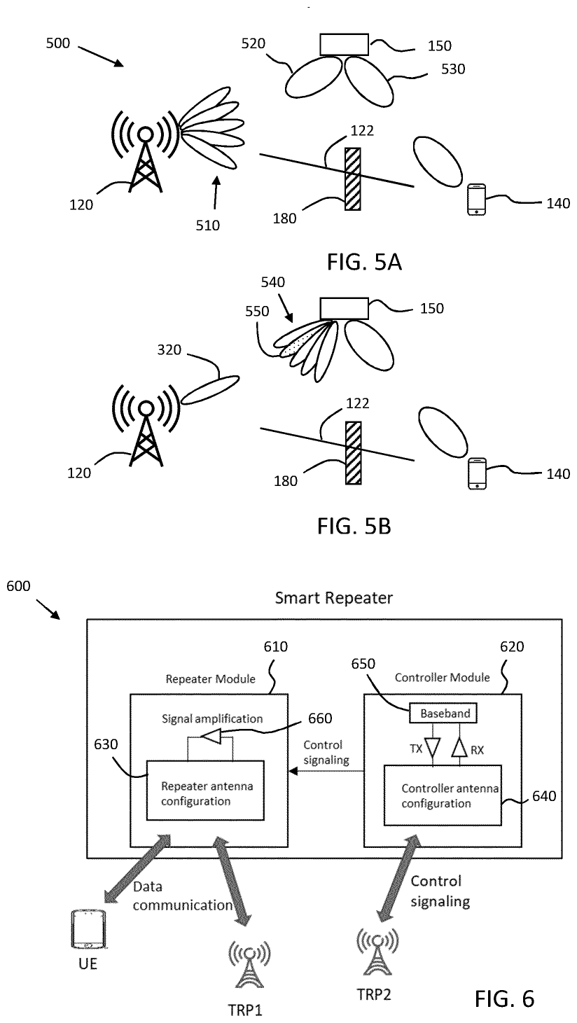

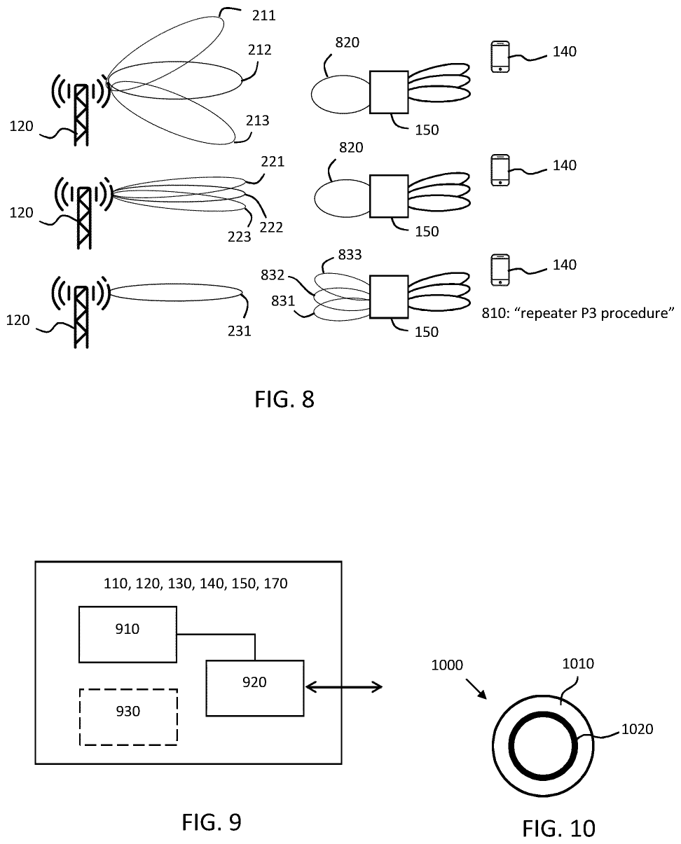

FIGS. 3 and 4 explain parts of the proposed scheme in more detail. Here, the setup is illustrated for the example scenario with a blockage in the direct gNB-UE link (denoted “Blocker” in FIGS. 3 and 4), as it is the use-case of interest for repeater nodes. The beam configuration 320, 330 between the repeater node 150 and the TRP 120 is here assumed known. Methods for configuring this beam pair will be discussed in more detail below, e.g., in connection to FIG. 5B and FIG. 8.

An example of the herein proposed methods for beam management involving a repeater node will now be given. In this example, we follow a two-step procedure for the joint beam management. First, with reference to FIG. 3, the gNB allocates multiple SBB beams, say, SSB1, SSB2 and SSB3, in the direction of the repeater node (all carried by beam 320), which in turn is configured to reflect these in different directions according to the coverage needs. An SSB beam is an example of a synchronization signal, and it is understood that the present disclosure is general in the sense that it is not limited to transmission of multiple SSB beams in the same direction. The number of synchronization signals sent from the network node 120 is determined by the number of outgoing repeater node beams, i.e., three instances in the example of FIG. 3. Also, the repeater node beam sweep is in this example synchronized with the repeated SSBs carried via the beam pair 320, 330. Receiving a message from the UE 140, a coarse direction towards the UE is found. For instance, in the example of FIG. 3, the repeater node beams 340 and 360 are found to be appropriate candidates for communication with the UE via the repeater node 150. Here, the received message can be based on some form of beam report from the UE or a BFRQ message for the cases with, e.g., blockage. Then, with reference to FIG. 4, after finding the coarse direction to the UE, the same procedure is applied with narrower beams, e.g., based on CSI-RS transmission, where the appropriate narrow beams of the gNB and the repeater node are determined. Here, multiple CSI-RS signals are transmitted in the direction of the repeater node (still all carried in beam 320) and then reflected by the repeater node in their associated directions, such that the appropriate narrow beams towards the UE are determined. In this example the SSBs are described as wider beams and the CSI-RS beams as narrower. That being the case depends on the capabilities of the repeater node, i.e., whether it is capable of forming wider and narrower beams. In case the gNB is capable and configured to transmit wide SSBs, it may be sensible to use such wide SSBs to form coverage within the direct cell coverage of the gNB. However, in the indirect cell coverage created by the repeater node, such a wide SSB (or any other beam for that matter) will only partially be reflected by the repeater node, and as a result, less energy is reflected. Hence, in the direction of the repeater node, the gNB is always using sufficiently narrow beams, and any beam widening is preferably managed by the repeater node but configured by the gNB.

Note that the concept of beam management involving a repeater node 150 can be seen as an expansion of some of the beams at the network node. In the example of FIG. 3, the relay antenna beam 320 has been expanded to three beams in FIG. 3, and then to four beams in FIG. 4. This type of antenna beam expansion is then managed by the beam management methods discussed herein. It is noted that the beam pair used to service the repeater node 150 is most likely relatively stable over time, i.e., will not need reconfiguration on a shorter time scale. Thus, the antenna beam-pair 320, 330 will most likely remain constant in many deployments. The beam-pair between repeater node 150 and the wireless device 140 on the other hand can be expected to need reconfiguration much more rapidly. This reconfiguration can in principle be achieved using legacy beams management, as long as the communications interface between the network node 120 and the control function of the repeater node 150 is fast enough to allow such reconfiguration.

As an example, one can consider the cases with a signal to interference and noise ratio (SINR) drop in the direct gNB-UE link (due to, e.g., blocking object, UE rotation, UE panel blocking by human tissue, etc.). In such cases, understanding that there is a situation with probable connection loss, we follow the proposed scheme to determine a backup repeater node-assisted link with the proper beams in the repeater node and the BS, and the UE will be served through the gNB-repeater node-UE link. In this way, the repeater node is integrated into the network and the UEs can be served with the gNB-repeater node-UE links. This, in turn, extends the network coverage and provides the UEs with fairly constant QoS.

In the examples described above the repeater node beams are synchronized with different gNB transmissions, for example synchronized to the transmission of SSBs. According to another example, the repeater node beams are synchronized to also support gNB receptions. In one example, the repeater node is configured to sweep the repeater node beams to match PRACH time slots. In NR, different PRACH time slots can be associated with different SSBs. This could be useful for example for a UE performing initial access and where the UE detects that a certain SSB is received with sufficient RSRP, then the UE can transmit a PRACH in a time slot that is associated with that identified SSB. In this way the gNB will receive information of a suitable SSB beam for that UE already during the PRACH reception (for example, if the UE transmit a PRACH in time slot 3, the gNB knows that the UE received the SSB associated with time slot 3 with sufficient RSRP). In case, different SSBs are associated with different repeater node beam (as described for DL above), we can sweep the repeater node beams in similar way for UL such that the same repeater node beam as used for a certain SSB beam during SSB transmission, also is used during the PRACH time slot associated with that SSB during PRACH reception.

In a similar way, the repeater node beam can be configured to match the uplink (UL) reception during other UL transmissions, like PUSCH/PUCCH/SRS transmissions. For example, in case the gNB triggers a UE with a certain UL transmission in slot n, then the gNB can configure the repeater node to apply a repeater node beam associated with that UE during slot n (for example if the applied Joint/UL TCI state for that UE is associated to SSB4, the repeater node could be configured to apply the repeater node beam that is associate with SSB4 during slot n).

It has been realized that the legacy beam management procedures discussed in connection to FIG. 2 can be re-used to at least partly configure the antenna system at the repeater node 150. In particular, for configuring the beam of the repeater node 150 which is directed towards the network node. FIG. 8 shows an example of the herein proposed methods for configuring the antenna system at the repeater for communication with the network node. The procedure for configuring the repeater preferred beam 832 for communicating with the network node 120 follows the same principle as the P3 procedure. With reference also to FIG. 5, the repeater node 150 configures an antenna system of the repeater node 150 to receive a radio signal from a network node 120, via one of the network node beams. This can be a wide beam 212 or a narrower beam 222, 231, as shown in FIG. 8. The repeater node then evaluates a signal quality metric, such as a signal strength metric, a BER, an SNR and/or an SINR for at least two candidate antenna beams 831, 832, 833 of the antenna system, and selects a preferred antenna beam 550, 832 out of the at least two candidate antenna beams for communication with the network node 120. The evaluation of the signal metric for selecting the preferred beam at the repeater node can be implemented as part of an ongoing communication with a wireless device 140 on the other side of the repeater. The selection of repeater beam for communication with the wireless device 140 will be discussed in more detail below.

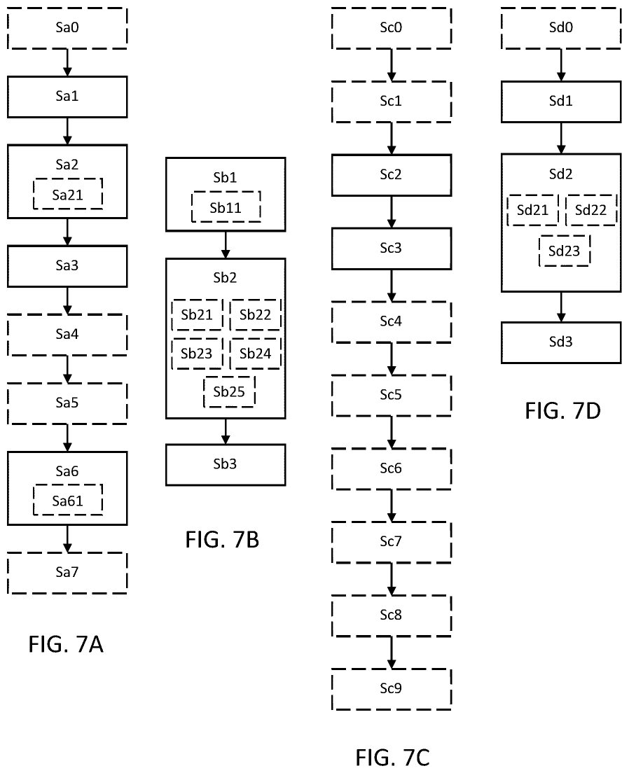

FIGS. 7A-C are flow charts which summarize the discussion up to this point. FIG. 7A illustrates example procedures suitable for being executed at a network node in order to make efficient use of a repeater node such as a network controlled repeater and/or an RIS. FIG. 7B show example operations which can be performed at a network node in order to improve the communication link to and from a repeater node. FIG. 7C illustrates some example operations which can be performed at a repeater node in order to improve communication with a wireless device. Finally, FIG. 7D shows some example operations which can be performed at the repeater node in order to improve the communication link to the network node.

FIG. 7A illustrates a computer implemented method performed in a network node 120, such as an access point in a wireless communication system 100. The access point may, e.g., be a gNB in a 3GPP defined network, or some form of configuration entity which control one or more configurations of the gNB. For instance, the wireless communication system may comprise a central configuration entity, perhaps part of the remote server device 170, which manages at least part of the configuration of the AAS in the network. The method comprises configuring Sa1 an AAS of the network node 120 to generate a relay antenna beam 320 associated with transmission to and from a repeater node 150 of the network node 120. With reference to FIG. 3 and FIG. 4, the relay antenna beam 320 is normally one out of a plurality of antenna beams 310 pointing in different directions from the network node 120, however, the relay antenna beam can also be a pre-determined setting in an adaptive AAS which is capable of directing beams in different directions, e.g., based on some form of antenna system adaptation algorithm. The relay antenna beam 320 can be assumed pre-configured in most scenarios of interest. Some example methods of determining such a pre-configuration will be discussed below in connection to FIG. 7B and FIG. 7D.

The method further comprises generating Sa2 at least two different first synchronization signals. Here, different means that the at least two synchronization signals are distinguishable from each other in the sense that they can be identified. An example of the property of being different in this sense is if the at least two different first synchronization signals are generated Sa21 as different SSBs. Another example of this property is if the at least two synchronization signals are generated as different CSI-RSs. Different can also mean that the synchronization signals comprise an identifier which makes it possible to distinguish them from each other, and respond to one synchronization signal in a manner which can be connected in an unambiguous manner to the synchronization signal in question. A technical effect of the feature of generating at least two different first synchronization signals is that a wireless device receiving one of the at least two different synchronization signals will be able to determine which synchronization signal has received and compose a response identifying the synchronization signal that is being responded to. Two consecutive SSB transmissions on the same beam are not “different” in this sense, since a receiver would not be able to distinguish a response to one of the signals from a response to the other, at least not in a straight forward and direct manner.

The method also comprises transmitting Sa3 the at least two different first synchronization signals via the relay beam 320 towards the repeater node 150. This means that the at least two synchronization signals will arrive at the repeater node 150, which allows the repeater node 150 to multiplex the different synchronization signals onto different reflected beams, i.e., the repeater node 150 receives the different synchronization signals and then forwards them on different beams out from the repeater node 150. This increases the number of effective antenna beams which the network node is capable of generating, since the relay antenna beam is expanded to at least two beams, where the beams are now “bent” in dog-leg fashion. This also allows the network node to effectively “bend” its generated beams to cover regions which are otherwise blocked. As will be understood from the following, a wireless device 140 receiving one of these outgoing repeater node beams will then be able to respond with a transmission back to the network node 120, allowing the network node to associate a repeater node beam-pair to use for communicating with the responding wireless device, i.e., as was discussed above in connection to FIG. 3 and FIG. 4.

According to some aspects, the method further comprises initially configuring Sa0 the repeater node 150 with a first configuration parameter prior to transmitting the at least two different first synchronization signals via the relay antenna beam 320. In this case the first configuration parameter is adapted to control a relaying characteristic of the repeater node 150, e.g., a relaying angle, a relaying direction, a relaying beam width, and/or an antenna pattern of the repeater node 150. The first configuration parameter adapted to control the relaying characteristic of the repeater node 150 may optionally also comprise a time instant and/or periodicity during which the first configuration parameter should be applied. The network node thus sets up the repeater node for forwarding the at least two first synchronization signals according to some strategy which may preferably comprise forwarding the at least two synchronization signals using relatively wide beams. However, the first configuration parameter may also comprise some other form of initial configuration which have deemed suitable for the communication scenario and environment at hand.

The number of first and/or second synchronization signals transmitted via the relay antenna beam 320 towards the repeater node 150 is optionally determined in dependence of a number of forwarding directions of the repeater node 150. This basically means that the network node has a-priori information indicative of the number of outgoing beams that the repeater node 150 is capable of generating, and/or configured to generate at some given point in time. The network node then interleaves this number of synchronization signals onto the relay beam 320, such that the different synchronization signals can be multiplexed onto the different outgoing beams from the repeater node, in order to perform a type of repeater node beam management, where the necessary synchronization signals for the beam management are provided by the network node on the relay beam 320. This again effectively amounts to an expansion of the relay antenna beam onto additional beams, extending the beam generating capability of the network node 120.

As discussed above, the method may also comprise receiving Sa4 a message at the network node 120 from a wireless device 140 via the relay antenna beam 320, wherein the message is indicative of a radio link quality between the network node 120 and the wireless device 140 via the repeater node 150. Here “radio link quality” is to be construed broadly to mean anything from a binary “received” vs (implicit) “not received” status, to more detailed channel state information (CSI) data indicative of the channel quality. The message received from the wireless device may comprise a response to one or more of the transmitted synchronization signals. The response from the wireless device optionally allows for a beam refinement procedure, by generating Sa6 at least two different second synchronization signals, and transmitting Sa7 the at least two different second synchronization signals via the relay antenna beam 320 towards the repeater node 150. The second synchronization signals may, e.g., be generated Sa61 as different channel state information reference signals (CSI-RS). For instance, the first synchronization signals may be relayed by the repeater node 150 using relatively broad beams, as shown in FIG. 3. Then, based on the response from the wireless device 140, the second synchronization signals can be transmitted on more narrow beams, as shown in FIG. 4.

As discussed above, it may also be advantageous to configure Sa5 the repeater node 150 with a second configuration parameter prior to transmitting the at least two different second synchronization signals via the relay antenna beam 320 towards the repeater node 150, where the second configuration parameter is adapted to control the relaying characteristic of the repeater node 150. The first configuration parameter is optionally associated with a lower degree of antenna beam directivity compared to the second configuration parameter, as exemplified above in connection to FIGS. 3 and 4.

The message received from the wireless device 140 may also comprise a beam failure recovery request (BFRQ) message or a beam report message. This operation may be used in case of sudden blockage, e.g., due to movement by the wireless device 140. The BFRQ message may trigger a recovery operation involving the activation of an alternative antenna beam.

So far, the relay antenna beam 320 from the network node 120 to the repeater node 150, and the corresponding receive antenna beam 330 at the repeater node have been assumed pre-configured. This beam-pair of course also needs to be configured in order for the network node to know which out of its beams 310, or which adaptive beam configuration to use for sending the plurality of different synchronization signals to the repeater node 150. However, it is often the case that this beam-pair is more stable compared to the beam-pair between the repeater node 150 and the wireless device 140, since the repeater node 150 is often stationary and deployed in a more or less static environment, while the wireless device 140 is mobile and can be assumed to both change position and orientation of its antenna system.

Thus, to benefit fully from network controlled repeaters and RIS, it may be preferred to adapt the beam management of the AAS at the network node 120 for transmission and reception to and from the repeater node 150, i.e., configuration of the beam-pair 320,330 in FIGS. 3 and 4. Particularly, different from, e.g., IAB nodes or the wireless devices, which receive the signal from a parent node as an end point, network controlled repeaters and RISs directly forward the received signal with some power amplification and/or phase rotation. Thus, to guarantee the required coverage extension, the beams received by such nodes should be in good shape/high power. Therefore, there is a need to design specific beams towards the network controlled repeaters/RISs such that the quality of the signal forwarded by these nodes is optimized. The relay beam configuration, once determined, can be stored in memory at the network node using the network controlled repeater and/or the RIS, such that it can be quickly reconfigured whenever it is desired to use the repeater node for communicating with a wireless device 140.

Following the identification of a network controlled repeater/RIS, specific (possibly, narrow) beams are designed and transmitted towards these nodes such that, the quality of the forwarded signal is improved. Moreover, depending on the nodes' capabilities, the determined transmission scheme at the gNB, etc., the network controlled repeater/RIS is configured properly. In this way, specific beams are designed, and the configurations remembered such that the coverage is extended and the UEs can be served through the network controlled repeater/RIS. To guarantee proper integration and operation of a network controlled repeater/RIS, one of the key points is to properly design the beam management scheme such that the network controlled repeater/RIS can be effectively used when required. Particularly, different from UEs/IAB nodes, in the network controlled repeaters/RISs the received signal is directly forwarded to the next nodes with some power amplification and/or phase rotation. This may affect the quality of the signal received by the destination node from the network controlled repeater/RIS transmission.

FIG. 7B illustrates a computer implemented method performed in a network node 120, such as an access point in a wireless communication system 100, for configuring the AAS of the network node 120 (i.e., operation Sa1 of the method illustrated in FIG. 7A). This method, which can be performed independently of the other methods discussed herein, comprises receiving Sb1 information related to the repeater node 150. The information related to the repeater node 150 can for instance involve reading from a file or receiving information about the relay from another network node.

The method also comprises determining Sb2 a configuration of the relay antenna beam 320 associated with transmission to and from the repeater node 150 of the network node 120 and storing Sb3 the configuration of the relay antenna beam together with information indicative of an identity of the repeater node 150. Thus, essentially, the network node 120 preconfigures the relay antenna beam 320 based on some form of information related to the repeater node. This information can, e.g., be obtained Sb11 from another network node 110, 170 and/or from a local storage medium 930 of the network node 120. The configuration of the relay antenna beam 320 can be achieved based on legacy beam management procedure with a UE served through the relay node, as exemplified in connection to FIG. 2 and also FIG. 8. The configuration of the relay antenna beam 320 can furthermore be achieved based on determining a suitable beam for communication with a controller module 620 of the repeater node. An example of such a controller module 620 was discussed above in connection to FIG. 6.

An example of the operations illustrated in FIG. 7B will now be provided. First a network node 120, such as a TRP of a gNB, receives information about a repeater node 150. In following operations, the network node determines a beam pair link between the network node and relay, where the beam pair link consists of one network node beam 320 (the relay beam) and a corresponding preferred beam 330 for use at the repeater node to communicate with the network node 120. In a third operation the network node configures the repeater node with the determined beam, and uses the repeater node for communicating with UEs.

In a first example operation, the network node receives information about the repeater node 150, i.e., the network controlled repeater or the RIS. Such an information can be achieved in different ways. In one embodiment, the information is obtained by reading a file or receiving information from another network node or network node.

In a second example operation, the network node determines a suitable network node beam and corresponding relay beam to be used for communication with UEs through the relay. This can be achieved, e.g., using one of the below listed example embodiments:

In a first example embodiment, the network node 120 has received coordinates of the repeater node 150, and together with the coordinates of the network node, the network node determines a line of sight (LOS) direction to the repeater node, i.e., a bearing, and based on that direction determines a suitable relay beam 320.

In a second example embodiment, the repeater node 150 performs a random access procedure according to established practice in modern wireless access networks, such as the 3GPP defined 4G, 5G and 6G networks. The network node 120 then established a connection with the repeater node 150 and the communication configuration results in the configuration of the relay beam 320. The random access procedure can be repeated periodically to verify that the configuration of the relay beam is still relevant. Also, the random access procedure can be repeated whenever signal quality of the communication via the relay beam decreases to no longer meet an acceptance criterion.

In a third example embodiment, the network node attains angle of arrival estimation of the repeater node based on communication with the controller module of the repeater node. Here we assume that the controller antenna configuration is co-located with the repeater antenna configuration, such that the angle of arrival estimate from the control module communication can be applied also on the repeater module. In a similar way, we assume that the angle of arrival estimation is performed either by the network node itself, or by a “secondary network node” that is co-located with the network node. Based on the angle of arrival estimation, the network node determines a suitable network node beam towards the repeater node.

In a fourth example embodiment, the network node performs beam sweep procedures with the controller module and re-use the determined beam for the repeater module.

In a fifth example embodiment, the repeater node can upon initialization configure itself to reflect in the same direction as it receives. With some supporting full duplex functionality, the network node will be able to detect the reflected signal and thereby know which beam to use.

Note that since the repeater node is fixed in position, the network node only needs to do this beam optimization on rare occasions (perhaps even only once, during the actual deployment of the relay-node).

Once the network node and repeater node beams for the network node-relay link has been determined, the network node configures the repeater node with the determined repeater node beam based on the determined transmission scheme. The repeater node configuration is transmitted to the controller module of the repeater node either directly from the network node or conveyed through another network node/network node. The configuration may depend on the repeater node type where with an RIS or a network controlled repeater the configuration may be a reflection configuration or a beamforming configuration, respectively. The network node then transmits towards the repeater node using the determined network node beam, and the repeater node forwards the signal based on the determined beam. In this way, the repeater node is integrated into the network and the quality of the signal forwarded by the relay node is improved. This, in turn, extends the network coverage and provides the UEs with fairly constant QoS even in the cases with, e.g., blockage.

Referring again to FIG. 7B, according to some aspects, as already mentioned, the method comprises determining Sb21 the configuration of the relay antenna beam 320 at least in part based on a geographical position of the repeater node 150 relative to the network node 120. The information related to the repeater node 150 may for instance comprise a relative geographical position of the repeater node, or, equivalently, a direction to the repeater node, which can be used by the network node to configure a suitable antenna beam for sending radio signals towards the repeater node 150.

According to other aspects, the method comprises determining Sb22 the configuration of the relay antenna beam 320 at least in part based on a beam management procedure involving a wireless device 140 served via the repeater node 150. Suppose for instance that the network node 120 configures a plurality of beams 510, perhaps in a plurality of directions, as illustrated in the example 500 in FIG. 5A, and optionally also configures the repeater node 150 to use relatively broad beams 520, 530, as also shown in the example 500 in FIG. 5A. Suppose further that the network node 120 receives a response from a wireless device 140 served via the repeater node 150 on one of these beams. The network node can then configure the relay antenna beam 320 as the beam associated with the response from the wireless device 140. In fact, much of the P1, P2 and P3 procedures can be re-used in this setting, by treating the repeater node 150 as the wireless device of the P1-P3 procedures. In this manner, the P3 procedure, executed with the repeater node 150 as the “UE”, will result in a selection of a preferred repeater node beam 550 to use in pair with the relay antenna beam 320.

According to other aspects, the method illustrated in FIG. 7B comprises determining Sb23 the configuration of the relay antenna beam 320 at least in part based on computer simulation involving a digital twin structure adapted to model at least a part of a wireless access network 100 comprising the network node 120 and the repeater node 150. A digital twin, in this context, is a model of the wireless access network deployed over some geographical region. Various parameter settings can be tested in the digital twin in order to evaluate the effect of the parameter setting on the actual wireless access network. This means that various candidate settings for the relay antenna beam 320 can be tested in the digital twin structure, and a suitable configuration thus extracted. Digital twin structures are generally known and will therefore not be discussed in detail herein.

The configuration of the relay antenna beam 320 can also be determined Sb24 at least in part based on radar operation involving the network node 120. According to an example, the repeater node 150 can be configured to reflect received signal energy back the way it came from, such as by using a van Atta structure or the like. The network node 120 can then sweep various candidate relay antenna beams and select a suitable one where signal energy is received back from the repeater node 150. The configuration of the relay antenna beam 320 can then be determined Sb25 at least in part based on reflection of the signal transmitted from the network node 120 towards the repeater node 150.

The various operations discussed herein also comprise operations performed at the repeater node 150. FIG. 7C provides some examples of such operations. FIG. 7C shows a flow chart illustrating a computer implemented method performed in a repeater node 150. The method comprises receiving Sc2 at least two different first synchronization signals from a network node 120 configured with a relay antenna beam 320 and configuring Sc3 a first relaying characteristic of the repeater node 150 to forward the received first synchronization signals differently from the repeater node 150.

According to some aspects of the method, it also comprises receiving Sc0 configuration data adapted for configuration of the first relaying characteristic. This configuration data may be sent to the repeater node, e.g., to a controller module 620 of a network controlled repeater. The configuration data may also be determined by a remote server, such as a processing device 170 in the core network of the wireless access system 100.

According to other aspects of the method in FIG. 7C, it comprises an operation of obtaining Sc1 time synchronization with respect to the network node 120. This time synchronization allows the repeater node to multiplex synchronization signals received from the network node onto respective outgoing beams, as illustrated in FIG. 3 and in FIG. 4, where the repeater node 150 receives a plurality of synchronization signals from the same direction (from the network node 120) and then sends the synchronization signals onwards in different directions to cover some pre-determined area which perhaps is not easily reached directly from the network node 120 using its AAS.

The method optionally also comprises receiving Sc4 at least two different second synchronization signals from the relay antenna beam 320 of the network node 120 and configuring Sc5 a second relaying characteristic of the repeater node 150 to forward the received second synchronization signals differently from the repeater node 150. The second synchronization signals were discussed above, they may advantageously be relayed using more narrow beams compared to the relaying of the first synchronization signals. This allows for the type of beam refinement procedures discussed above.

As discussed above, the first and/or second relaying characteristic comprises any of: a relaying angle, a relaying direction, a relaying beam width, and/or a relaying power amplifier setting. The first and/or second relaying characteristic optionally also comprises a time instant and/or periodicity during which the respective first and/or second configuration should be applied

The method may furthermore comprise adapting Sc6 the first and/or second relaying characteristic in dependence of a random access frame structure of the network node 120.

According to some aspects, the method comprises adapting Sc7 the first and/or second relaying characteristic in dependence of an uplink, UL, format of the network node 120. For instance, PUSCH/PUCCH/SRS transmission formats may be of interest here.

The method may furthermore comprise synchronizing Sc8 a change in relaying angle, relaying direction, and/or relaying beam width of the repeater node 150 in dependence of a SSB beam time structure of the network node 120. This allows the network node to send the plurality of synchronization signals in a time division duplex manner via the same relay antenna beam towards the repeater node 150, which may then multiplex the different synchronization signals onto different outgoing beams in different directions, in order to provide an increased coverage area of the network node. The method may for instance comprise synchronizing Sc9 a change in relaying angle, relaying direction, and/or relaying beam width of the repeater node 150 in dependence of a random access frame time structure of the network node 120.

FIG. 7D illustrates a computer implemented method performed in a repeater node 150. The method comprises configuring Sd1 an antenna system of the repeater node 150 to receive a radio signal from a network node 120, evaluating Sd2 a signal quality metric for at least two candidate antenna beams 540 of the antenna system, and selecting Sd3 a preferred antenna beam 550 out of the at least two candidate antenna beams 540 for communication with the network node 120. Hence, the method can be used to configure the preferred beam 540 for communicating with the network node 120. Aspects of this method was discussed above in connection to FIG. 8, where it was noted that the operations involved in configuring the antenna beam at the repeater node 150 for communicating with the network node 120 can be set up in a manner similar to the operations involved in the P3 procedure used for beam management today.

According to some aspects, the method comprises receiving Sd0 information related to the repeater node 150, where the antenna system of the repeater node 150 is at least partly configured based on the received information. This information may allow a more efficient set-up of the repeater node beam used for communicating with the network node 120.

According to some other aspects, the method comprises evaluating Sd21 the at least two candidate antenna beams 540, 831, 832, 833 based on a beam management procedure involving a wireless device 140 served via the repeater node 150.

According to some further aspects, the method comprises evaluating Sd22 the at least two candidate antenna beams 540 based on a received signal power and/or based on a measured SINR.

The methods discussed herein may also comprise performing Sd23 a random access procedure by the repeater node 150 with respect to the network node 120. The repeater node may comprise hardware for performing random access with respect to the network node. This hardware may be realized in a relatively low complex manner, not necessarily comprising hardware for decoding a communication signal. The hardware may be adapted to detect random access synchronization signals transmitted from the network node and generate a suitable response to the random access signals form the network node.

FIG. 9 schematically illustrates, in terms of a number of functional units, the general components of a network node according to embodiments of the discussions herein. Processing circuitry 910 is provided using any combination of one or more of a suitable central processing unit CPU, multiprocessor, microcontroller, digital signal processor DSP, etc., capable of executing software instructions stored in a computer program product, e.g., in the form of a storage medium 930. The processing circuitry 910 may further be provided as at least one application specific integrated circuit ASIC, or field programmable gate array FPGA.

Particularly, the processing circuitry 910 is configured to cause the device to perform a set of operations, or steps, such as the methods discussed in connection to FIGS. 7A-D and the discussions above. For example, the storage medium 930 may store the set of operations, and the processing circuitry 910 may be configured to retrieve the set of operations from the storage medium 930 to cause the device to perform the set of operations. The set of operations may be provided as a set of executable instructions. Thus, the processing circuitry 910 is thereby arranged to execute methods as herein disclosed. In other words, there is shown a network node comprising processing circuitry 910, a network interface 920 coupled to the processing circuitry 910 and a memory 930 coupled to the processing circuitry 910, wherein the memory comprises machine readable computer program instructions that, when executed by the processing circuitry, causes the network node to transmit and to receive a radio frequency waveform.

The storage medium 930 may also comprise persistent storage, which, for example, can be any single one or combination of magnetic memory, optical memory, solid state memory or even remotely mounted memory.

The device may further comprise an interface 920 for communications with at least one external device. As such the interface 920 may comprise one or more transmitters and receivers, comprising analogue and digital components and a suitable number of ports for wireline or wireless communication.

The processing circuitry 910 controls the general operation of the device e.g., by sending data and control signals to the interface 920 and the storage medium 930, by receiving data and reports from the interface 920, and by retrieving data and instructions from the storage medium 930. Other components, as well as the related functionality, of the control node are omitted in order not to obscure the concepts presented herein.

FIG. 10 illustrates a computer readable medium 1010 carrying a computer program comprising program code means 1020 for performing the methods illustrated in, e.g., FIGS. 7A-D, when said program product is run on a computer. The computer readable medium and the code means may together form a computer program product 1000.

1. A computer implemented method performed in a network node, the method comprising
configuring an advanced antenna system, AAS, of the network node to generate a relay antenna beam associated with transmission to and from a repeater node of the network node, the method further comprising
generating at least two different first synchronization signals, and
transmitting the at least two different first synchronization signals via the relay antenna beam towards the repeater node.

2. (canceled)

3. The method according to claim 1, further comprising configuring the repeater node with a first configuration parameter prior to transmitting the at least two different first synchronization signals via the relay antenna beam, where the first configuration parameter is adapted to control a relaying characteristic of the repeater node.

4. The method according to claim 3, where the relaying characteristic of the repeater node comprises any of: a relaying angle, a relaying direction, a relaying beam width, an amplification setting, an antenna pattern of the repeater device, and/or a time instant and/or periodicity during which the first configuration parameter should be applied.

5. (canceled)

6. The method according to claim 1, wherein the method further comprises:
receiving a message at the network node from a wireless device via the relay antenna beam, wherein the message is indicative of a radio link quality between the network node and the wireless device via the repeater node,
generating at least two different second synchronization signals, and
transmitting the at least two different second synchronization signals via the relay antenna beam towards the repeater node.

7. (canceled)

8. The method according to claim 6, further comprising
configuring the repeater node with a second configuration parameter prior to transmitting the at least two different second synchronization signals via the relay antenna beam towards the repeater node, where the second configuration parameter is adapted to control the relaying characteristic of the repeater node, wherein
the first configuration parameter is associated with a lower degree of antenna beam directivity compared to the second configuration parameter.

9. (canceled)

10. The method according to claim 6, wherein the message received from the wireless device comprises a beam failure recovery request, BFRQ, message or a beam report message.

11. The method according to claim 1, where the repeater node is a reconfigurable intelligent surface, RIS, or a network controlled repeater node.

12. The method according to claim 1, wherein the number of first and/or second synchronization signals transmitted via the relay antenna beam towards the repeater node is determined in dependence of a number of forwarding directions of the repeater node.

13. The method according to claim 1, wherein configuring the AAS of the network node further comprises
receiving information related to the repeater node,
determining a configuration of the relay antenna beam associated with transmission to and from the repeater node of the network node, and
storing the configuration of the relay antenna beam together with its associated repeater node.

14. The method according to claim 13, comprising obtaining the information related to the repeater node from another network node and/or from a local storage medium of the network node.

15. The method according to claim 13, wherein the method comprises:
determining the configuration of the relay antenna beam at least in part based on a geographical position of the repeater node relative to the network node;
determining the configuration of the relay antenna beam at least in part based on a beam management procedure involving a wireless device served via the repeater node;
determining the configuration of the relay antenna beam at least in part based on computer simulation involving a digital twin structure adapted to model at least a part of a wireless access network comprising the network node and the repeater node;
determining the configuration of the relay antenna beam at least in part based on radar operation involving the network node; and/or
determining the configuration of the relay antenna beam at least in part based on reflection of a signal transmitted from the network node towards the repeater node.

16. (canceled)

17. (canceled)

18. (canceled)

19. (canceled)

20. A computer implemented method performed in a repeater node, the method comprising
receiving at least two different first synchronization signals from a network node configured with a relay antenna beam, and
configuring a first relaying characteristic of the repeater node to forward the received first synchronization signals differently from the repeater node.

21. (canceled)

22. (canceled)

23. The method according to claim 20, comprising
receiving at least two different second synchronization signals from the relay antenna beam of the network node, and
configuring a second relaying characteristic of the repeater node to forward the received second synchronization signals differently from the repeater node.

24. The method according to claim 20, where the first and/or second relaying characteristic comprises any of: a relaying angle, a relaying direction, a relaying beam width, an amplification setting, a relaying power amplifier setting, and/or a time instant and/or periodicity during which the respective first and/or second configuration should be applied.

25. (canceled)

26. The method according to claim 20, wherein the method comprises:
adapting the first and/or second relaying characteristic in dependence of a random access frame structure of the network node, and/or
adapting the first and/or second relaying characteristic in dependence of an uplink, UL, format of the network node.

27. (canceled)

28. The method according to claim 20, wherein the method comprises:
synchronizing a change in relaying angle, relaying direction, and/or relaying beam width of the repeater node in dependence of a SSB beam time structure of the network node; and/or
synchronizing a change in relaying angle, relaying direction, and/or relaying beam width of the repeater node in dependence of a random access frame time structure of the network node.

29. (canceled)

30. The method according claim 20, where the repeater node is a reconfigurable intelligent surface, RIS, or a network controlled repeater node.

31. A computer implemented method performed in a repeater node, the method comprising
configuring an antenna system of the repeater node to receive a radio signal from a network node,
evaluating a signal quality metric for at least two candidate antenna beams of the antenna system, and
selecting a preferred antenna beam out of the at least two candidate antenna beams for communication with the network node.

32. The method according to claim 31, comprising
receiving information related to the repeater node, where the antenna system of the repeater node is at least partly configured based on the received information.

33. The method according to claim 31, wherein the method comprises:
evaluating the at least two candidate antenna beams based on a beam management procedure involving a wireless device served via the repeater node; and/or
evaluating the at least two candidate antenna beams based on a received signal power and/or based on a measured signal-to-noise and interference ratio, SINR.

34. (canceled)

35. (canceled)

36. (canceled)

37. (canceled)

38. (canceled)
